(19) United States
(12) Patent Application Publication
(10) Pub. No.: US 2006/0209072 A1
(43) Pub. Date: Sep. 21, 2006

(54) Image-based vehicle occupant classification system

(76) Inventors: Marc Jairam, Scarborough (CA); Richard Smith, Toronto (CA); Finn Wredenhagen, Toronto (CA); Ghanshyam Rathi, Mississauga (CA); Peter Metford, Mississauga (CA)

Correspondence Address: CLARK HILL, P.C., 500 WOODWARD AVENUE, SUITE 3500, DETROIT, MI, 48226, US

(21) Appl. No.: 11/385,942

(22) Filed: Mar. 21, 2006

Related U.S. Application Data
(60) Provisional application No. 60/663,652, filed on Mar. 21, 2005.
(60) Provisional application No. 60/699,248, filed on Jul. 14, 2005.

(51) Int. Cl. G06T 11/20

(52) U.S. Cl. 345/440

(57) ABSTRACT

A system and method for processing acquired images to develop useful classifications of subjects such as occupants of a vehicle preferably employs a hierarchical and probabilistic structure, such as a Bayesian Network to analyze acquired images and produce a meaningful classification. The structure preferably includes set of analyzers, a set of Scenario analyzers and a set of Temporal models which are arranged in three respective hierarchical layers. Each respective analyzer operates on the acquired image and, in some circumstances, feedback from the Scenario analyzers, to produce an output representing the probability that a feature that the respective analyzer is concerned with is present in the acquired image. Each respective Scenario analyzer receives output probabilities from at least one of the analyzers and, in some circumstances, feedback from the Temporal Models, to produce an output indicating the probability that a scenario that the respective Scenario analyzer is concerned with, is the scenario captured in the acquired image. Each respective Scenario analyzer can also provide feedback inputs to one or more analyzers to alter their operation. Finally, each respective Temporal Model receives and operates on the output from at least one Scenario analyzer to produce a probability that a classification with which the Temporal Model is concerned is represented by the acquired image. Each respective Temporal Model can also provide feedback inputs to one or more Scenario analyzers to alter their operation. The structure processes the classification probabilities output from the Temporal Models to produce a classification for the acquired image.

### RELATED APPLICATIONS

This application claims priority from U.S. Provisional Patent Applications 60/663,652, filed Mar. 21, 2005, and 60/699,248, filed Jul. 14, 2005 and the contents of both of these provisional applications are incorporated herein by reference.

### FIELD OF THE INVENTION

The present invention relates to a system and method for determining information relating to the interior of a vehicle. More specifically, the present invention relates to a image-based method of determining a classification of occupants of a vehicle.

### BACKGROUND OF THE INVENTION

Many passenger and other vehicles are now equipped with active restraint systems, such as airbags, to protect vehicle occupants in the event of an accident. However, while such active restraint systems can in many cases prevent or mitigate the harm which would otherwise occur to a vehicle occupant in an accident situation, in some circumstances it is contemplated that they can exacerbate the injury to the vehicle occupant.

Specifically, active restrain systems such as airbags must deploy rapidly, in the event of an accident, and this rapid deployment generates a significant amount of force that can be applied to the occupant. In particular, children and smaller adults can be injured by the deployment of airbags as they both weigh less than full sized adults and/or they may contact a deploying airbag with different parts of their bodies than would a taller adult.

For these reasons, regulatory agencies have specified the operation and deployment of airbags. More recently, regulatory bodies, such as the National Highway Transportation and Safety Administration (NHTSA) in the United States, have mandated that vehicles be equipped with a device that can automatically inhibit deployment of the passenger airbag in certain circumstances, such as the presence of a child in the passenger seat or the seat being empty. To date, such systems have been implemented in a variety of manners, the most common being a gel-filled pouch in the seat base with an attached pressure sensor which determines the weight of a person in the passenger seat and, based upon that measured weight, either inhibits or permits the deployment of the airbag.

However, such systems are subject to several problems including the inability to distinguish between object placed on the seat and people on the seat, the presence of child support seats, etc.

It has been proposed that vision based sensor systems could solve many of the problems of identifying and/or classifying occupants of a vehicle but, to date, no such system has been developed which can reliably make such determinations in real world circumstances wherein lighting conditions, the range of object variability, materials and surface coverings and environmental factors can seriously impede the ability of the proposed image-based systems from making a reliable classification.

It is desired to have a image-based system and method that can reliably categorize the occupant status of a vehicle seat to permit the safe operation of active restraint systems.

### SUMMARY OF THE INVENTION

It is an object of the present invention to provide a novel image-based occupant classification system and method which obviates or mitigates at least one disadvantage of the prior art.

According to a first aspect of the present invention, there is provided an image-based occupant classification system to produce a classification of an occupant of a seat in a vehicle, comprising: an image acquisition system for acquiring images of the seat in the vehicle; an image processing device receiving the acquired images and: examining the acquired images with a plurality of analyzers to seek and identify a set of features in the acquired images, the outputs of the analyzers representing probabilities that the features are visible in the acquired images; processing the outputs of the analyzers in at least two scenario analyzers, each of the at least two scenario analyzers operating on at least two of the analyzer outputs, each scenario analyzer examining the analyzer outputs to identify the occurrence of a respective predefined scenario within the acquired images and to produce an output representing a probability that the acquired image represents the predefined scenario; and processing the output of the at least two scenario analyzers in at least two temporal models, each temporal model processing the at least two scenario analyzer outputs in conjunction with previous outputs from the scenario analyzer outputs to produce a classification of an occupant in the seat of the vehicle.

According to another aspect of the present invention, there is provided a method of producing a classification of the occupant of a vehicle seat, comprising the steps of: (i) acquiring at least one image of the interior of the vehicle; (ii) examining the at least one acquired image with a plurality of analyzers to assign probabilities that each respective one of a set of features is visible in the at least one acquired image and outputting the assigned probabilities; (iii) processing the output assigned probabilities with a set of scenario analyzers, each scenario analyzer having a different predefined scenario of interest associated therewith and accepting at least two assigned probabilities as inputs to determine and output the probability of the predefined scenario of interest occurring in the acquired image; and (iv) processing the output probabilities of the predefined scenarios of interest occurring with at least two temporal models, each temporal model considering the present and at least one previous output probabilities of the predefined scenarios of interest occurring to produce a classification of the occupant of the seat.

The present invention provides a system and method for processing acquired images to develop useful classifications of subjects such as occupants of a vehicle. The system and method preferably employs a hierarchical and probabilistic structure, such as a Bayesian Network to analyze acquired images and produce a meaningful classification. The structure preferably includes set of analyzers, a set of Scenario analyzers and a set of Temporal models which are arranged in three respective hierarchical layers. Each respective analyzer operates on the acquired image and, in some circumstances, feedback from the Scenario analyzers, to produce an output representing the probability that a feature that the respective analyzer is concerned with is present in the acquired image. Each respective Scenario analyzer receives output probabilities from at least one of the analyzers and, in some circumstances, feedback from the Temporal Models, to produce an output indicating the probability that a scenario that the respective Scenario analyzer is concerned with, is the scenario captured in the acquired image. Each respective Scenario analyzer can also provide feedback inputs to one or more analyzers to alter their operation. Finally, each respective Temporal Model receives and operates on the output from at least one Scenario analyzer to produce a probability that a classification with which the Temporal Model is concerned is represented by the acquired image. Each respective Temporal Model can also provide feedback inputs to one or more Scenario analyzers to alter their operation. The structure processes the classification probabilities output from the Temporal Models to produce a classification for the acquired image.

### BRIEF DESCRIPTION OF THE DRAWINGS

Preferred embodiments of the present invention will now be described, by way of example only, with reference to the attached Figures, wherein:

FIG. 1 shows a block diagram of an image-based occupant classification system in accordance with the present invention; and

FIG. 2 shows a block diagram of an image processing and decision making structure of the image-based occupant classification system of FIG. 1.

### DETAILED DESCRIPTION OF THE INVENTION

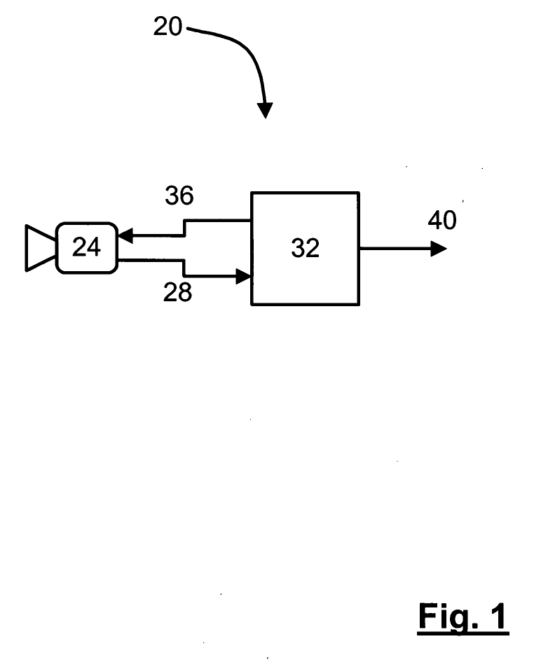

An image-based occupant classification system is indicated generally at 20 in FIG. 1. As used herein, the term “classification” is intended to comprise identifying the occupant, or lack of occupant, with respect to a set of classifications including at least those classifications defined by safety regulations or statute. Presently, such classifications include different classifications representing different sizes of adult occupant, different sizes of child occupant and different configurations of children in child restraint seats. As will be apparent from the following discussion and explanations, the present invention is not limited to operation with any particular set of classifications and can instead easily be adapted as desired to classify vehicle occupants according to any desired classification scheme.

Further, as will be also apparent from the discussion below, the present invention is not limited to use with any particular hardware configuration and/or equipment and the configuration of FIG. 1 is solely intended to be one representative example of such hardware.

System 20 includes a camera 24 suitable for installing in a vehicle. Camera 24 can employ a CCD sensor or any other suitable sensor for acquiring images of regions of the interior of the vehicle which are of interest. Camera 24 need not operate at any particular frame rate, but it is preferred that camera 24 be able to provide multiple images per second.

As will also be apparent to those of skill in the art, camera 24 should be able to acquire images in the expected range of illumination levels and dynamics within the vehicle and thus camera 24 can be equipped with an electronic aperture to vary exposure and/or a supplemental lighting system (such as an array of Infrared LEDs, not shown) to illuminate portions of interest of the interior of the vehicle, if required. Camera 24 can also operate, if desired, to acquire different types of images, such as monochrome and color images or visible light and infrared images.

While the embodiment illustrated in FIG. 1 includes a single camera 24, the present invention is not so limited and can be employed with multiple cameras 24 and such multiple cameras 24 can be located to acquire images of a desired location from different angles and/or with different sensing modalities, i.e.—visible light vs. infrared, monochrome versus color images etc.

The acquired images 28 are provided by camera 24 to image processing device 32. The operation of image processing device 32 is described in detail below and image processing device 32 includes a memory to hold at least one image, and preferably two or more images, captured by camera 24 and processing means to analyze the captured images as described below. It is contemplated that the processing means will comprise one or more digital signal processors (DSPs), although it is also contemplated that general purpose processor devices, such as those manufactured by Intel or AMD, can also be employed instead of, or in combination with DSP processors, if desired.

Image processing device 32 can also provide signals 36 to control the operation of camera 24 to, for example, change operating modes of camera 24 to activate a supplemental lighting system associated with camera 24, etc. Image processing device 32 also produces at least one output 40, indicating a determined occupant classification or other desired information (such as error conditions), which is available to other vehicle systems, such as active restraint systems, etc. The construction of output 40 is not particularly limited and can be in a variety of formats and/or arrangements as may be required by the devices and/or systems receiving output 40. It is contemplated that, in a preferred embodiment, output 40 will be compatible with a data communication bus employed in the vehicle.

The present inventors have recognized that in real world environments it is impossible or impractical to achieve a reliable classification of vehicle occupants from any single image processing algorithm. While a single algorithm might be successfully developed for many situations, factors such as the wide dynamic range of lighting conditions in the vehicle, the presence of cargo or objects which may be in the vehicle, etc. prevent a single algorithm from providing reliable results over the expected vehicle occupancy conditions.

Accordingly, the present inventors have determined five principles that are employed in system 20 to obtain reliable image-based classifications in real world environments such as the interior of passenger compartments of vehicles.

The first principle is that the image-based classification of vehicle occupants is probabilistic in nature. Thus, determinations cannot be made with absolute certainty and that results must be treated statistically.

The second principle is that it is unreliable to analyze an image with a single analyzer. Instead, it is desirable to analyze the image with multiple analyzers, each of which is attempting to identify a particular limited, or simple, feature or characteristic in the image. In this manner, any individual analyzer can return an unreliable or incorrect result while, provided one or more other analyzer returns results which are more correct, a correct classification can reliably be obtained.

The third principle is that it is preferred that at least two analyzers analyze the image to identify the same feature or characteristic of the image. As is well known in sensor theory, the outputs of two weak sensors can be combined statistically to obtain a result with a higher probability of correctness than could be obtained from either individual sensor. Ideally, in the present invention when two or more analyzers are employed to identify the same feature or characteristic of the image, the individual analyzers employ different analysis techniques (i.e. different algorithms or imaging modalities—such as visible light versus infrared light).

The fourth principle is that the knowledge gained (determinations made) by an analyzer, or other system component, should be propagated appropriately, both through feed forward and feedback techniques, to other system components to enhance the probability of their outputs.

Finally, the fifth principal is that the complexity of the required system should be managed through the use of abstraction within the system and a hierarchical structure for the system.

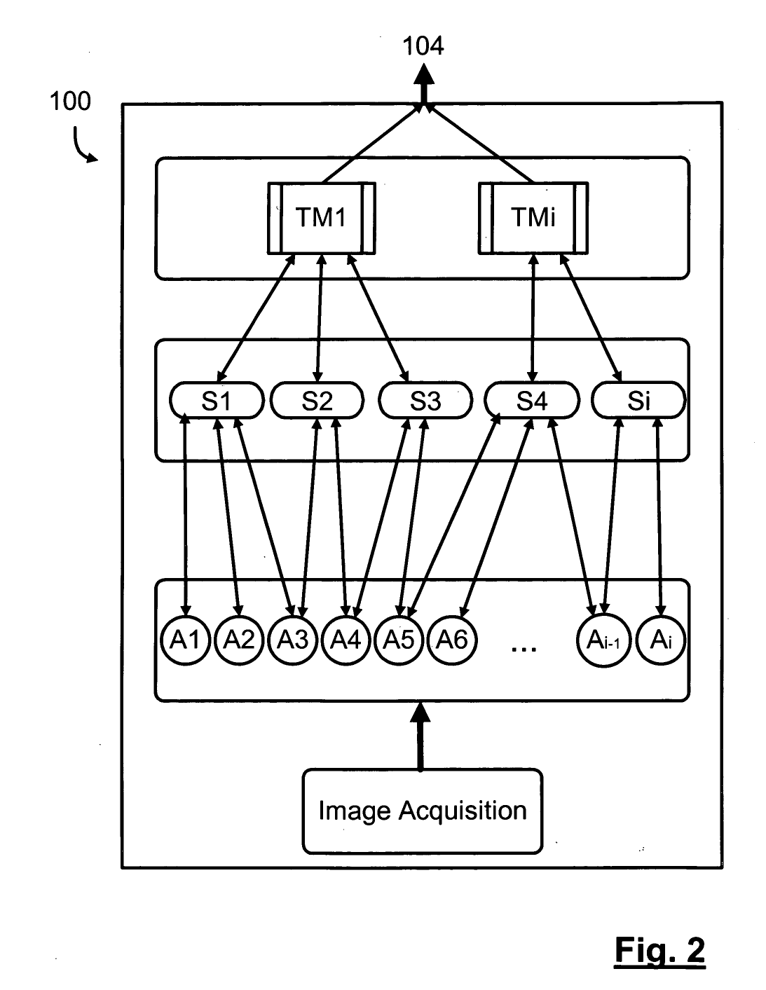

FIG. 2 shows a representation of a present embodiment of the processing structure utilized in image processor device 32 in accordance with the five principles discussed above. Processing structure 100 comprises a Bayesian Network with the nodes of the network arranged in three hierarchical layers. Bayesian Networks are well known to those of skill in the art and will only be briefly described herein. A Bayesian Network is a probabilistic graph-based structure that is capable of modeling domains comprising uncertainty. A Bayesian Network includes a set of nodes representing variables and arcs representing dependence relations among the variables. A node can represent any kind of variable, be it an observed measurement, a parameter, a latent variable, or a hypothesis and nodes are not restricted to representing random variables.

The strength of the graph-based model is not only that it enables uncertainty reasoning with hundreds of variables, but also that it helps humans to better understand the modeled domain, mainly due to comprehensible representation by use of directed acyclic graphs representing dependencies between domain variables.

In the presently preferred Bayesian Network, the links in the network are the only mechanisms that enable the flow of data. Each node is a simple and autonomous processor, communicating to neighbouring nodes only in the layer above or below. The impact of each new piece of evidence is viewed as a perturbation that propagates through the network via message-passing between connected nodes.

Each node, after its internal processing is complete, outputs a probability or likelihood that its hypothesis is true. This is the feed-forward data. For analyzers (described below) the hypothesis can be such things as “feature x” is in position “y”; for Scenario analyzers (described below) the hypothesis can be such things as “a rear-facing child restraint is in the seat”, “the seat is empty” and so on, while the hypothesis for Temporal Models (described below) is “the classification is x”. The range of possible probabilities within a node is described by a probability density function (pdf). When a node's processing starts, there is an initial pdf or “prior”. The prior can be shaped by data passed to it by a higher-level node (feedback data).

The feed-forward input drives the generation of the node's hypotheses and the feedback from the higher level nodes provides information to bias or shape the prior at lower level nodes. Hierarchical Bayesian graphs are considered as concurrent across multiple nodes so successive nodes in the hierarchy can constrain each other's inferences in small loops, quickly and continuously. The system will tend to converge rapidly to a consistent interpretation of the visual scene incorporating low level and high-level sources of information.

Each of the nodes in the network is an instantiation of a generic Bayesian hierarchical decision node. Information flows across the graph links in the following manner:
1. Likelihood-based information is fed forward from lower level nodes and multiplied together to form the higher-level input map. The use of the multiplication operator for combining the forwarded likelihoods is consistent with random variable theory that proves that the pdf of the sum of two random variables is the convolution of their pdfs. It enables the combining of multiple redundant lower level nodes to increase the system reliability. This multiplication may take the form of a convolution, scalar-vector or vector element product and, generally, it is quite node dependent.
2. Higher-level context information is fed back from higher level nodes to lower-level nodes. A lower level node's prior is biased by this feedback information through the injection of new parameters (for example, a new search area) into the node's detection technique(s).

In particular, the feedback from the higher level nodes includes all possible ways in which higher-level information about the acquired image may affect lower level nodes. As an example, illumination data from a higher level node makes probable the fact that certain areas of the image are in shadow which can affect how lower level nodes identify features.

The nodes cooperate to share information representing pieces of understanding about the acquired image in a manner that increases a node's likelihood. The cooperation is best described as a “preponderance of opinion” rather than a competition between possible objects and their models. This is a superior approach when the feature detectors are relatively weak as they inherently are in single camera, real world conditions.

While the present invention preferably employs a Bayesian Network as its probabilistic and hierarchical structure, the present invention is not so limited and any other appropriate probabilistic structure, which will occur to those of skill in the art, can be employed instead.

It is also presently preferred that the present invention employ Condensation as a significant technique to increase its performance. Condensation (CONditional DENSity PropagATION) is a recent development in the theory of real time feature detection and tracking in highly cluttered images. Generally, condensation is a Monte Carlo implementation of Kalman tracking theory as generalized to non-Gaussian scenarios. Condensation is rooted in ideas from statistics, control theory and computer vision. To track outlines and features of foreground objects as they move in substantial clutter and to achieve this at video frame-rates is difficult. Condensation provides a highly scalable, methodical, predictable and simple method that detects, classifies and tracks objects. With condensation, each analyzer manages its own stochastics. As a result, structure 100 can systematically analyze the vehicle interior environment, extract features and objects of interest, develop dynamical models for these features and objects and analytically predict the performance of the solutions. As condensation is well known, it will not be further discussed herein in any detail.

In structure 100, the lowermost level comprises a layer of analyzer nodes A1 through Ai. Each analyzer node A1 through Ai can access acquired images, either in the native image space or in derived spaces, such as edge maps or motion maps, and operate to perform an image processing analysis on the image to identify a feature within the acquired image. Preferably, the image processing analysis is a relatively simple image processing task concerned with a small area or characteristic of the image and each analyzer outputs a likelihood, or “goodness of fit” measure to one or more of the nodes of the next level in the hierarchy of structure 100 indicating the probability that the feature being detected by the analyzer is present in the acquired image.

As will be apparent, the raw data of a single acquired image is limited in scope, e.g. sets of x, y coordinates and luminance (or RGB) values for each pixel within the image. While pixel changes across time represent extremely useful information, which can be used for tracking and other purposes, it is presently preferred that at least some of the analysis of analyzers A1 through Ai be made on the basis of static acquired images, in order to conform with legislated requirements for occupant classification systems in North America.

The second layer of structure 100 comprises a set of Scenario analyzers. As used herein, the term “scenario” is intended to comprise a specific understanding of an image in terms of features that can be detected by the detected set of analyzers that it receives output from. Each Scenario analyzer generates the probability that a scene is in a certain state (i.e.—the scenario analyzer's hypothesis), with respect to occupancy. These hypothesis might be “empty seat”, “object on seat”, “seated child”, “child restraint”, “adult properly seated”, “adult in crash position”, etc.

Each Scenario analyzer (S₁ through Sᵢ):
Receives data, in the form of likelihoods, from multiple analyzers about features in a scenario it is detecting;
“Understands” an acquired image in terms of objects that it creates from the feature data using heuristic rules;
Outputs the likelihood of its detected scenario to the layer above; and
Receives data from the layer above.

The complete set of Scenario analyzers covers the range of situations in the vehicle interior for which system 20 must determine a classification. As the number of possible classifications increases, so too must the number of Scenario analyzers.

The third layer of structure 100 comprises a set of Temporal Models (nodes TM₁ through TMᵢ) and each Temporal Model:
Receives likelihood data from multiple scenario analyzers;
“Understands” an acquired image as a set of objects with dynamic behaviour over time;
Analyzes the Scenario likelihoods and temporal data with internal heuristic rules in order to output a classification to external systems.

The understanding of an acquired image takes place in all three levels of structure 100, according to the hierarchy of features [symbol] objects [symbol] temporal models. At the lowermost analyzer level, “understanding” is constrained to features that algorithms can know, such as edge locations, patterns, simple dynamics, etc. The resulting feature sets are understood at the Scenario level in terms of objects consisting of a number of features and the Scenario analyzers output a set of objects and their probablities. Objects, inherently more abstract than features, do not concern themselves with the details of edges or patterns but only of object attributes and behaviours.

The set of objects, in turn, are understood in time by the Temporal Models. In a similar fashion to the Scenario analyzers, the Temporal Models are more abstract yet and do not concern themselves with the details of the objects or features. This hierarchical structure isolates and maintains abstractions and keeps inferences and decisions at appropriate levels. In this way much of the complexity of the system is managed.

As mentioned above, in order to obtain high probability identification of features it is preferred to analyze each acquired image in as many different ways (modalities) as possible and to provide non-correlated redundancy with respect to detecting as many features as possible. Thus structure 100 preferably employs multiple, simultaneous, cooperating analyzers on each acquired image.

In general, an analyzer attempts to detect a single feature within an acquired image. As used herein, the term “feature” is not intended to be unduly limited and some examples of features include vehicle seat parts (e.g. front seat edges, side edges, the headrest, etc.), fixed vehicle interior components (e.g. door edges, window edges, instrument panel edges etc.), parts of child restraint systems, human anatomical features such as legs, thighs, torsos, head etc.

An analyzer typically contains a representation of the feature it is looking for in the acquired image as well as a detection mechanism to analyze the acquired image to determine the presence of the feature. The representation in an analyzer of a feature can be: as simple as a single line; somewhat more complex, such as a combination of edges and textures; or quite complex, using equations of possible motions, etc. Additionally the feature which an analyzer attempts to detect need not be a directly visible real-world element, but can instead be a detectable pattern or characteristic contained within transformation data obtained, for example, through a Fourier Transform or another aspect of the acquired image. Similarly, the detection mechanism in an analyzer can be simple, such as a classical image filter, or quite complex, involving dynamics and thus involving positions and velocities.

One example of a class of analyzer is B-Spline analyzers. Generally, the man-made objects, or static portions of objects, in a vehicle interior can be modeled as a curve or family of curves representing a feature of interest. In particular, quadratic B-splines can be used to represent the curves of such objects in an acquired image as B-splines represent complex curves with a very small numbers (ten to twenty) of anchor points and that these anchor points can be moved en-mass according to a heuristically derived dynamical equation of motion.

If an edge representing a feature of interest can be defined within a clearly-defined region of an acquired image and if it is unique within that region-of-interest and if a normal measurement line linear filter can be defined, then a very high level of detection performance for that feature can be achieved using condensation.

Once the B-spline curve for a given feature has been constructed, it is placed on the acquired image in the location corresponding to its state and its likelihood, measured by the goodness of how well the curve fits the image data. Normal displacement or other suitable techniques can be employed to measure the normal component of the distance between the constructed curve and the target curve in the acquired image.

However, B-spline-based analyzers alone are inadequate to detect human shapes, which can be ill-defined and/or highly variable. Generic B-spline curves using measurement line linear filters generally do not provide robust performance in detecting human shapes.

Another example of a class of analyzer is the Amorphous Pattern Machine. Shapeless (e.g. amorphous) detection is enabled using patterns combining both texture and edges. The amorphous pattern machine is essentially a non-linear filter applied to the usual measurement lines normal to a B-spline representing a particular feature within the overall condensation framework. Amorphous patterns combining both edge and texture can be used to describe various features such as thighs, arm sleeves and heads. These patterns are applied to a state description of each measurement line obtained by scanning the line and seeking “UP”, “LEVEL” and “DOWN” pixel value transitions. This technique can be used to extract partial occlusion information needed for the indirect features.

A high level description of an amorphous pattern machine is:
1. For a given feature, a b-spline is specified and positioned on the acquired image and a set of measurement lines are constructed.
2. For each measurement line, the state pattern (a sequence of “UP”, “LEVEL” and “DOWN” states) is generated and then matched to the feature's specified target pattern and a local goodness of fit result is output.
3. These outputs from all of the matches are assembled and a final aggregate goodness of fit is calculated.

For step 2 above, preferably, a non-linear statistical smoothing filter is used to extract the pattern from the measurement line. A state engine extracts the pattern as a sequence of UP, LEVEL and DOWN states. The two parameters “Level Trigger” and “Level Threshold” control the extraction. For example, if consecutive pixel values exceed the Level Threshold value and continue to do so when the pixels are separated by the Level Trigger value then the state switches to “UP”.

Each feature specifies its own Level Threshold and Level Trigger values. This allows more general control of the pattern extraction. It can also be desirable to iterate on the pattern generation and vary the Level Trigger and Level Threshold values which enables robust pattern extraction for widely varying dynamic range situations.

Each state is represented by a 4-tuple: state; pixelStartValue; length; and pixelEndValue. The generated pattern is a set of these tuples. If too many state-tuples are generated, then the Level Threshold and Level Trigger values are too small, or the measurement line is very noisy and the pattern generation should be abandoned or iterated for this measurement line. Generally, the number of allowed state-tuples must be managed to comply with hardware limitations in image processor 32, such as the amount of level one cache available in the hardware of image processor 32.

The particular target pattern sought for by an amorphous pattern machine is feature-specific. The target pattern syntax along with the state engine used to fit the pattern to the measurement line's generated pattern is described below.

The basic target pattern syntax is a set of 2-tuples (states, length) where “states” is an arbitrary concatenation of specific states and “length” is the duration of the tuple. A value of “0” can be employed to signify a “don't care” length. While it may be tempting to allow these tuples to be recursive, this is an unnecessary complication.

For example, to detect the thighs of an anthropomorphic test dummy, a pattern of {(UD15), (UD10)} can be specified. This pattern represents two cylinders where the first cylinder has a width of 15 pixels and the second cylinder has a width of 10 pixels. The pattern analyzer will search the measurement line's generated pattern for the first tuple and then start searching for the second tuple.

“UDn” tuple defines an UP state followed by a DOWN state over a span of n pixels. This might be too restrictive, and can be modified to be “ULDn” which specifies a LEVEL state between the UP and DOWN states. Even less restrictively, a tuple of “UXDn” can be specified, where the “X” represents a “don't care” state, so that the target pattern may or may not have LEVEL state between the UP and DOWN states.

The attraction of such amorphous models is that they are inherently non-linear and are well suited to the detection of typically loosely-defined humanoid shapes. Amorphous pattern machines have been successfully used to detect ATDs, some child seats and human situations as well as basic seat features.

Yet another example of a class of analyzers are Adaboost Trained analyzers. In addition to purposefully engineered detection analyzers, such as the above-mentioned B-Spline analyzers, automated observation methods can be coupled with specific detection techniques. In particular, Adaboost trained analyzers have been found to be very effective within the condensation framework for detecting specific kinds of objects such as empty seats and rear-facing infants seats (RFIS).

Adaboost combines decision rules to form a strong Hypothesis [H(x)] according to

$$H ( x ) = {\sum }_{n} {h}_{n} ( x ) * {α}_{n}$$

where:
hₙ is a weak learner; and
αₙ is the weight, determined through training.

Typically in image processing a Haar wavelet decomposition is run on a region-of-interest (ROI) within an acquired image. Measurements are made in boxes contained in the ROI and then compared to a threshold to make a classification. Haar wavelets conveniently yield a multi-scaled approximation to a horizontal and vertical edge map. For pattern recognition problems, such as empty seat and RFIS, a small widow is selected within the original image and Haar wavelet decomposition is run on the ROI. The Haar wavelet is a simple square wave with positive and negative halves of length each of length T/2.

This decomposition is a separable operation performed by edging the image with a small kernel horizontally and then vertically. Each detector from the equation above is made up of n boxes. For example, in each box the black region is subtracted from the white region. This subtraction is compared to a threshold to determine whether the term an is added or subtracted from the total Hypothesis.

Another class of analyzer is Power Grid analyzers. The Power Grid analyzer is quite different from either the B-Spline or Amorphous analyzers in that it does not use classical image processing techniques to search for a given feature in an image. Instead, the data contained in the image undergoes a transformation and the resulting data is searched for the target feature. The Power Grid takes a region-of-interest that covers the seat area in all of its possibilities and performs a discrete cosine transform (DCT) on that grid. The DC (0,0) portion of the output is discarded and what remains represents the “energy” contained within the image. In descriptive terms, the energy (hence the term power grid) is a kind of representation of the texture of the image while ignoring its color. The energy content of an image varies greatly depending on whether or not the seat is occupied and the size of the occupant. The set of results across all types and sizes of occupants gives a kind of approximate signature for each situation. There is much overlap between situations and thus the Power Grid is considered a weak classifier.

Another class of analyzer is the Motion analyzer. Motion in regions-of-interest can be determined by use of several techniques. A Fast-Fourier Transformation can be used and analysis of energy and frequency differences between two or more acquired images, where changes greater than a certain threshold, indicates the presence of significant motion. Additionally multiple edge changes within a set of ROIs can also be used.

Another class of analyzer is the Quality of Service (QoS) analyzer. If there is any degradation of an image because of environmental reasons or hardware failure then this knowledge is propagated throughout structure 100 through QoS analyzers. One instance of QoS analyzer uses histograms to determine if appropriate levels of light are reaching the sensor, a second instance analyzes sets of edge transitions for acutance (an aspect of sharpness) in order to determine if there are any focus issues, while a third instance uses template matching to determine if any shift in the field-of-view has occurred.

As should be apparent to those of skill in the art, many other classes of analyzers can be employed with the present invention including, but not limited to:
Correlation mapping analyzers: A Correlation map specifies the direction and strength of motion for various regions of interest. It is a source of micro-motion information that can be utilized by structure 100 and FFT-based techniques can be used to generate the map;
Linear mapping analyzers: A linear map specifies the location and direction of straight lines found in the image. Typically, this is generated using a radon transform. The linear map can be used to provide evidence of boxes or other non-humanoid characteristics in the seat area;
Texture mapping analyzers: A texture map specifies areas of texture or wrinkle activity. This can be used to provide evidence of clothing or other humanoid characteristics in the seat area or footwell;
Optical flow analyzers: can employ optical flow analysis techniques;
Morphological erosion analyzers: can employ morphological erosion analysis techniques;
Standard Filter-based analyzers: can employ Haar, Canny, Hough and other standard filters;
Contour snakes analyzers: can analyze contours in acquired images;
Phase correlation analyzers: can phase correlations in acquired images; and Additionally, analyzers are not limited to image-processing and can instead include one or more analyzers based upon other sensing technologies including, without limitation, ultrasound, time of flight sensing, radio frequency, etc. In such cases, system 20 can include multiple sensors, one or more of which employ a sensing technology other than image sensing.

Different sets of analyzers are required for use in low-light situations, although they are, in general, simple variation of their regular-light counterparts. For example a simple amorphous analyzer would work in the same geography in both normal and infrared-illuminated situations, but the rate of edge drop-off and its direction might well be different.

In structure 100, the analyzers in the lowest level of the hierarchy provide theiroutputs to, and accept inputs, from the scenario analyzers S₁ through Sᵢ of the middle layer. The middle layer is where “objects” are created from the input data derived from the analyzers of the lower level, combined with guidance data received from the topmost layer of structure 100 which comprises a set of Temporal analyzers, described below.

This middle layer of Scenario analyzers is where meaning begins to be established from the set of “clues” that the analyzers of the lowermost layer provides; or stated differently, where the probability of a Scenario hypothesis is determined by the statistical combination of the probabilities received from the many weak classifiers (analyzers) that contribute to the calculation.

As shown in FIG. 2, the Scenario analyzers aggregate information from the analyzers, feed information forward to the Temporal Models and control the analyzers using feedback by biasing their probability density functions (pdfs). In turn, the Scenario analyzers are controlled and guided via feedback from the higher-level Temporal Models.

Each Scenario analyzer is implemented as a state engine whose state is a function of the likelihoods supplied to it as inputs from analyzers. Scenario analyzers do not perform direct image processing, instead each Scenario analyzer uses sets of rules to determine a probability for its base hypothesis. Thus Scenario analyzer S₁ directs analyzers A₁, A₂ and A₃ and is in turn directed by Temporal Model TM₁.

Each Scenario analyzer generates the probability that an acquired image is in a certain state (its hypothesis), with respect to occupancy. These states might be “empty seat”, “object on seat”, “seated child”, “child restraint”, “adult properly seated”, “adult in crash position”, etc. These probabilities are provided to the Temporal Models in uppermost layer of structure 100.

Motion and QOS analyzers can be used by all Scenario analyzers to decide if it is worthwhile evaluating the Scenario's hypotheses at all. If there is too much motion or the images are too degraded, for example, it is not worthwhile even attempting an analysis, while intermediate situations are used with appropriate modifications to probabilities.

It is believed that one of the main strengths of structure 100 is the feed-forward and feedback mechanisms inherent in its structure. For example, if Scenario S₁ is “Empty Seat”, then the respective features being considered by analyzers A₁, A₂, A₃ can be specific parts of the seat. Each analyzer A₁, A₂ and A₃ reports independently and appropriate logic in Scenario analyzer S₁ will dictate if the reported feature likelihoods can reasonably comprise an empty seat.

Scenario analyzer S₁ will guide analyzers A₁, A₂ and A₃ to reasonable relative positions by providing feedback control data such as possible seat positions, or other parameters. In this way, many locations for the seat can be tested in a reasonable fashion and the interactions within S₁ start to form a dynamic model of the seat. It is believed that this is a superior approach than to search for the seat as a whole, using a complex internal model.

Additionally this structure allows for analyzers A₁ and A₂ to be detectors for the same feature and, provided they operate in different modalities, this can greatly improve robustness. This is particularly effective when neither analyzer A₁ or A₂ detects the feature with high probability.

In the “Empty Seat” scenario, S_{(ES)} it has been found that a minimum of two amorphous analyzers are required , one which looks for the front seat edge, A_{(FSE)}, and one that looks for the back edge of the seat cushion, A_{(BSE)}. Initially, A_{(FSE)} and A_{(BSE)} look for their respective features independently of each other based on preliminary search start positions in a condensation cycle. After A_{(FSE)} and A_{(BSE)} provide their outputs to S_{(ES)} via their pdfs, it can be decided by S_{(ES)} that, while each probability is quite high, the two edges are too far apart to be an actual seat.

S_{(ES)} will then bias the two sets of search parameters to look in different locations and then start another condensation cycle of A_{(FSE)} and A_{(BSE)} which will process their hypothesis again and provide their respective outputs to S_{(ES)} which determines if the results are reasonable, i.e.—if the positions could correspond to an empty seat. If S_{(ES)} determines that the reported results are not reasonable, then new positions are tried, and so on. Structure 100 rapidly converges on the best result—with maximized probabilities of each analyzer achieved through a mechanism referred to herein as “preponderance of opinion”.

In this example, if the seat is actually occupied rather than empty, then S_{(ES)} will never receive high probabilities from A_{(FSE)} and A_{(BSE)} regardless of the feedback it provides to A_{(FSE)} and A_{(BSE)} and thus S_{(ES)} would then generate a low probability of its hypothesis being true, as expected.

In general, S_{(ES)} conducts a structured cooperative negotiation between the analyzers by biasing sets of search parameters. A_{(FSE)} and A_{(BSE)} never know about each other and the context of the two is understood only by S_{(ES)}. Similarly, the Temporal models in the uppermost layer of structure 100 understand the scene context in ways that Scenario analyzers in the middle layer of structure 100 do not.

It is important to note that, in broad terms, the information that analyzers provide is of the form of what can be detected or “seen”, while at the Scenario analyzer level the meaning or context of these results is determined. Additionally, that which cannot be “seen” is equally important.

Clearly, locating seat fragments is useful for other Scenario analyzers and thus a given analyzer can provide it's output to multiple Scenario analyzers, In FIG. 2, analyzer A₃ interacts with scenario analyzers S₁ and S₂, where A₃ might be a headrest detector and S₂ might be “50% percentile male adult properly seated” scenario. In this example we might expect that analyzer A₃ outputting a very low probability that the headrest has been found would support the hypothesis of S₂.

The general analysis of what features of the interior of the vehicle cannot be seen is called occlusion analysis—as something is blocking or in front of the feature being sought, thus occluding it.

It is possible, for example, to have numerous analyzers searching for various seat parts and, by combining that which can be seen with that which is occluded, a Scenario analyzer can effectively arrive at a kind of silhouette, or cutout, of what is in the seat without having directly detected it. Accordingly, in structure 100, many of the seat-based amorphous analyzers are used for dual purposes—direct use, as in the case of S_{(ES)} and indirect use, detecting occupants and their orientations.

Direct analyzers, as the name suggests, locate features that directly belong to the human or anthropomorphic test dummy (ATD) objects. The complex object of a human is modeled as sets of interacting simple objects such as legs, arms etc. The analyzer probabilities (pA_{(feet)}, pA₍ₖₙₑₑₛ₎, pA_{(thighs)}, pA₍ₜₒᵣₛₒ₎, pA_{(head)}, etc.) will be combined using simple dynamic modeling rules to decide if the set of positions are plausible and self-consistent.

The combination of direct and indirect analyzers has been found to be quite powerful and is the preferred method of detecting objects in a three dimensional world with two dimensional image data, as is presented with a single camera.

Each Scenario analyzer employs a set of rules that are evaluated in view of the probabilities returned by a set of analyzers and which are specific to each Scenario analyzer. Informally, the rules take the form of Boolean-like statements such as, “if the seat front edge is not seen and legs are seen and the headrest is partly seen and a head is seen, then the probability of an adult properly seated is p”.

More formally, the rules take the form of interpolative Boolean chains but with a major difference—whereas binary 0,1 are the responses to a strictly Boolean operation, in the interpolative form fractional values are allowed. The fractions are inherent to the probabilistic nature of any feature detection—we can never say with certainty that feature x exists, rather we can say that we are (for example) 93% confident that feature x is present.

Yet, it is desired to make rules based on whether or not feature x is detected. This is achieved through use of membership functions. This allows partial membership in sets like A∪B (in Boolean terms: A AND B). Typically, each Scenario analyzer has a complex set of rules, often containing dozens of membership functions.

The topmost level of structure 100 comprises a set of Temporal Models, TM₁ through TMᵢ. Temporal Models understand the contexts in which the Scenarios of the Scenario analyzers exist. Like the Scenario analyzers of the layer below, each Temporal Model is a state machine and is a function of the likelihoods or probabilities of its Scenario analyzers.

Each Temporal Model, as the name suggests, is a time-based repository for all of the accumulated high-level information in structure 100. It contains the most highly abstract data in the structure, in the form of models of humans, car seats and so on. The input to a given Temporal Model TM_{X} is a set of Scenario probabilities {p(Sᵢ), . . . , p(Sₓ)}. These results are combined in interpolated Boolean chains (employing membership functions), similar to the Scenario analyzers, to yield a probability of a certain classification. These classifications can be quite simple and, in the case of a vehicle occupant classification for controlling active restraint devices, can be “Empty Seat”, “Adult”, “Child”, etc. or more sophisticated, for example with further positional or size distinctions, as desired.

The classifications take the form of interpolative Boolean equations as modified to form membership functions. For example:
TM1=S1 AND S2 OR S3
TM2=S1 OR S2 AND S4
TM3=. . .

where a probability is generated for each TMₓ.

In the absence of historical data, however this would represent the final decision of the system but the Temporal Model operates to reconcile the current result with what has already happened. It can be that the current result represents an unlikely situation, such as a very rapid change from an “Empty Seat” state to an “Adult” state without having gone through a transition state. For example, an adult cannot change into a child without having first gone through an empty seat or a very chaotic transition. The state model is easily expanded as finer granularity is required . e.g. for different-sized adults, etc. The Temporal Model arbitrates when the current result and the previous result are in conflict. This is achieved using heuristics based on system hysteresis rules and other suitable mechanisms and this arbitration provides the basis for the feedback) control to the Scenario analyzers.

For the purposes of vehicle occupant classification, the Temporal Model layer only needs to understand if the most likely Scenario is reasonable based on the previously Scenario likelihoods. If not, for example if an adult quickly changed to a child, then the Temporal Model can choose to: suppress the results; wait for further clarification; modify the Scenario analyzer inputs through feed-back; etc. The final output 104 from the Temporal Model layer is an occupant classification for use in other vehicle car systems, most notably, the passenger-side airbag controller.

From the description given above, it will now be recognized that the present invention provides a novel and effective system and method for processing acquired images to develop useful classifications of subjects such as occupants of a vehicle. The system and method preferably employs a hierarchical and probabilistic structure, such as a Bayesian Network to analyze acquired images and produce a meaningful classification. The structure preferably includes set of analyzers, a set of Scenario analyzers and a set of Temporal models which are arranged in three respective hierarchical layers.

Each respective analyzer operates on the acquired image and, in some circumstances, feedback from the Scenario analyzers to produce an output representing the probability that a feature that the respective analyzer is concerned with is present in the acquired image.

Each respective Scenario analyzer receives output probabilities from at least one of the analyzers and, in some circumstances, feedback from the Temporal Models, to produce an output indicating the probability that a scenario that the respective Scenario analyzer is concerned with, is the scenario captured in the acquired image. Each respective Scenario analyzer can also provide feedback inputs to one or more analyzers to alter their operation.

Finally, each respective Temporal Model receives and operates on the output from at least one Scenario analyzer to produce a probability that a classification with which the Temporal Model is concerned is represented by the acquired image. Each respective Temporal Model can also provide feedback inputs to one or more Scenario analyzers to alter their operation.

The structure processes the classification probabilities output from the Temporal Models to produce a classification for the acquired image.

Preferably, two or more analyzers operate on acquired images to identify the same feature using different modalities to increase the probability that accurate detection of a feature occurs. Further, preferably condensation, or a similar technique, is employed throughout the structure to enhance performance.

The above-described embodiments of the invention are intended to be examples of the present invention and alterations and modifications may be effected thereto, by those of skill in the art, without departing from the scope of the invention which is defined solely by the claims appended hereto.

We claim:

1. An image-based occupant classification system to produce a classification of an occupant of a seat in a vehicle, comprising:
an image acquisition system for acquiring images of the seat in the vehicle;
an image processing device, the image processing device operating to receive the acquired images and:
examine the acquired images with a plurality of analyzers to identify a set of features in the acquired images, the outputs of the analyzers representing probabilities that the predefined features are visible in the acquired images;
process the outputs of the analyzers in at least two scenario analyzers, each of the at least two scenario analyzers operating on at least two of the analyzer outputs, each scenario analyzer examining the analyzer outputs to identify the occurrence of a respective predefined scenario within the acquired images and to produce an output representing a probability that the acquired image represents the predefined scenario; and
process the output of the at least two scenario analyzers in at least two temporal models, each temporal model processing the at least two scenario analyzer outputs in conjunction with previous outputs from the scenario analyzer outputs to produce a classification of an occupant in the seat of the vehicle.

2. The image-based occupant classification system of claim 1 wherein the analyzers, scenario analyzers and temporal models are connected as nodes in a probabilistic decision mechanism.

3. The image-based occupant classification system of claim 2 wherein the probabilistic decision mechanism is a Bayesian Network.

4. The image-based occupant classification system of claim 3 wherein the number of analyzers exceeds the number of features, at least two analyzers operating to identify the same feature.

5. The image-based occupant classification system of claim 4 wherein the at least two analyzers each employ a different algorithm or method to identify the feature.

6. The image-based occupant classification system of claim 4 wherein the at least two analyzers each employ a different imaging modality to identify the feature.

7. The image-based occupant classification system of claim 6 wherein at least one analyzer operates on a visible light image and at least one other analyzer operates on an infrared image.

8. The image-based occupant classification system of claim 6 wherein at least one analyzer operates directly on the image and at least one other analyzer operates on transformation data derived from the image.

9. The image-based occupant classification system of claim 3 wherein the Bayesian Network employs condensation.

10. The image-based occupant classification system of claim 1 wherein the image acquisition system comprises a solid state camera.

11. The image-based occupant classification system of claim 10 wherein the image acquisition system further comprises an infrared light source and the camera can acquire images from both visible light and infrared light.

12. The image-based occupant classification system of claim 1 wherein the produced classification is provided to an active restraint system in the vehicle to modify operation of the active restraint system.

13. The image-based occupant classification system of claim 1 wherein the image acquisition system further comprises at least one sensor acquiring information relating to the interior of the vehicle using a non-image sensing technology and wherein the image processing device is further operable to examine and process the acquired information from the at least one senor in addition to the acquired images.

14. A method of producing a classification of the occupant of a vehicle seat, comprising the steps of:
(i) acquiring at least one image of the interior of the vehicle;
(ii) examining the at least one acquired image with a plurality of analyzers to assign probabilities that each respective one of a set of predefined features is visible in the at least one acquired image and outputting the assigned probabilities;
(iii) processing the output assigned probabilities with a set of scenario analyzers, each scenario analyzer having a different predefined scenario of interest associated therewith and accepting at least two assigned probabilities as inputs to determine and output the probability of the predefined scenario of interest occurring in the acquired image; and
(iv) processing the output probabilities of the predefined scenarios of interest occurring with at least two temporal models, each temporal model considering the present and at least one previous output probabilities of the predefined scenarios of interest occurring to produce a classification of the occupant of the seat.

15. The method of claim 14 where step (ii) comprises having at least two analyzers assign a probability that a respective one of a set of predefined features is visible in the at least one acquired image, each of the at least two analyzers employing a different algorithm or method to identify the respective one predefined feature.

16. The method of claim 14 where step (ii) comprises having at least two analyzers assign a probability that a respective one of a set of predefined features is visible in the at least one acquired image, each of the at least two analyzer employing a different modality to identify the respective one predefined feature.
